(19) United States
(12) Patent Application Publication
(10) Pub. No.: US 2013/0169670 A1
(43) Pub. Date: Jul. 4, 2013

(54) ELECTRONIC DEVICE AND METHOD FOR TRANSMITTING SLIDE FILE DURING SLIDE FILE PRESENTATION

(71) Applicant: XIN GUO, Shenzhen City (CN)

(72) Inventor: XIN GUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/450,503

(22) Filed: Apr. 19, 2012

(30) Foreign Application Priority Data
Dec. 28, 2011 (CN) 201110448401.X

(51) Int. Cl. G09G 5/00; G06K 9/54

(52) U.S. Cl. 345/619; 382/305

(57) ABSTRACT

An electronic device includes a projecting module, a display module, a wireless communication module, and a control module. The projecting interface connects the electronic device to a projector. The display module displays one or more slide files. The control module receives a request for downloading a displayed slide file from a terminal, determines a corresponding slide file according to the received request if more then one of the one or more slide files are displayed, and transmits the determined slide file to the terminal via the wireless communication module during the slide file presentation.

### BACKGROUND

1. Technical Field

The present disclosure relates to electronic devices and methods for slide file presentation and, more particularly, to an electronic device and a method for transmitting slide files during slide file presentation.

2. Description of Related Art

Slide files pre-stored in a computer can be shown to attendees by projecting the slide files to a display screen via a projector connected to the computer. Sometimes, during presenting the slide files, attendees want to download a certain slide file which they are interested in to their mobile terminals. However, the slide file usually cannot be downloaded until the presentation is finished.

Therefore, what is needed is a means to solve the problem described above.

### BRIEF DESCRIPTION OF THE DRAWINGS

Many aspects of the present disclosure can be better understood with reference to the following drawings. The elements in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an electronic device, in accordance with an embodiment.

FIG. 2 is a flowchart of a method for transmitting slide file during slide file presentation, in accordance with an embodiment.

### DETAILED DESCRIPTION

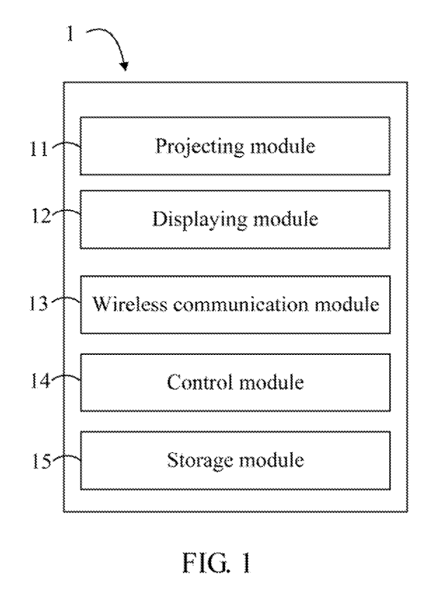

FIG. 1 is an exemplary embodiment of an electronic device 1. The electronic device 1, such as a computer, is capable of displaying slide files selected by a presenter and then projecting the displaying slide files via a projector (not shown) to a display screen (not shown). In the embodiment, the electronic device 1 includes a projecting interface 11, a display module 12, a wireless communication module 13, and a control module 14.

The projecting interface 11, such as a video graphics array (VGA) interface or a digital video interface (DVI), connects the electronic device 1 to the projector. The display module 12 displays one or more slide files, thereby the one or more displayed slide files are allowed to be projected via the projecting interface 11 to the display screen. The control module 14 receives a request for downloading a displayed slide file from a terminal via the wireless communication module 13, and determines whether more than one of the one or more slide file is displayed in response to the received request. If only one slide file is displayed, the control module 14 obtains the currently displayed slide file and transmits the obtained slide file to the terminal via the wireless communication module 13 during the slide file presentation. If more than one slide file is displayed, the control module 14 determines the corresponding slide file according to the received request, and transmits the determined slide file to the terminal via the wireless communication module 13 during the slide file presentation. The wireless communication module 13 is a wireless access port, and the communication between the electronic device 1 and the terminal through the wireless communication module 13 may be carried out via any suitable wireless network protocol such as WIFI, Bluetooth, for example.

In the embodiment, the received request includes an image which is captured from a page of one of the displayed slide files. The terminal sends the request including the captured image to the electronic device 1. If more than one slide file is determined to be displayed, the control module 14 of the electronic device 1 extracts characters from the captured image, searches the characters in the displayed slide files to determine the corresponding slide file according to the received request. In the embodiment, the determined slide file is compressed and transmitted to the terminal. The way the control module 14 determines the corresponding slide file according to the received request is not limited thereto and can be varied according to need.

In the embodiment, the control module 14 further determines whether the at least one terminal is authorized to receive the determined slide file, and transmits the determined slide file to the terminal only when the terminal is authorized to receive the determined slide file. In this case, the electronic device 1 further includes a storage module 15 to store a variety of authorized attendees and information associated with the authorized attendees. The information includes a unique identifier of the requesting terminal, for example the cell phone number of the mobile phone. The control module 14 obtains the unique identifier of the requesting terminal after receiving the request from the requesting terminal, compares the current unique identifier with all unique identifiers in the storage module 15, and determines that the terminal is authorized if the current unique identifier matches one of the unique identifiers in the storage module 15.

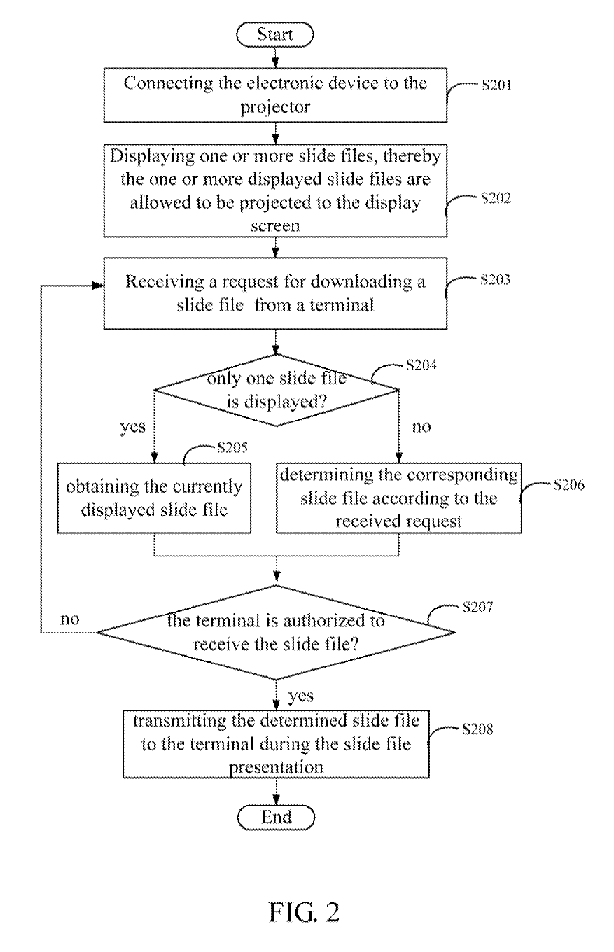

FIG. 2 is a flowchart of a method of transmitting slide file during slide file presentation according to an exemplary embodiment.

In step S201, the projecting interface 11 connects the electronic device 1 to the projector.

In step S202, the display module 12 displays one or more slide files, thereby the one or more displayed slide files are allowed to be projected via the projecting interface 11 to the display screen.

In step S203, the control module 14 receives a request for downloading a displayed slide file from a terminal via the wireless communication module 13.

In step S204, the control module 14 determines whether only one slide file is displayed in response to the received request, if yes, the procedure goes to step S205; otherwise, the procedure goes to step S206.

In step S205, the control module 14 obtains the currently displayed slide file.

In step S206, the control module 14 determines the corresponding slide file according to the received request.

In step S207, the control module 14 determines whether the terminal is authorized to receive the slide file, if yes, the procedure goes to step S208; otherwise, the procedure goes back to step S203.

In step S208, the control module 14 transmits the determined slide file to the terminal via the wireless communication module 13 during the slide file presentation.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a projecting interface to connect the electronic device to a projector;
a display module to display one or more slide files;
a wireless communication module; and
a control module to receive a request for downloading a displayed slide file from a terminal, determine a corresponding slide file according to the received request if more then one of the one or more slide files are displayed, and transmit the determined slide file to the terminal via the wireless communication module during the slide file presentation.

2. The electronic device as described in claim 1, wherein the control module obtains the displaying slide file and transmits the obtained slide file to the terminal via the wireless communication module during the slide file presentation if only one slide file is displayed by the displayed module.

3. The electronic device as described in claim 1, wherein the received request comprises an image captured from a page of one of the displayed slide file by the terminal, and the control module extracts characters from the captured image and searches the characters in the displayed slide files to determine the corresponding slide file according to the received request if more than one of the one or more slide files are determined to be displayed.

4. The electronic device as described in claim 3, wherein the determined slide file is compressed and transmitted to the terminal.

5. The electronic device as described in claim 1, wherein the control module further determines whether the terminal is authorized to receive the determined slide file before transmitting the determined slide file to the terminal, and transmits the determined slide file to the terminal if the terminal is authorized to receive the determined slide file.

6. The electronic device as described in claim 5, further comprising a storage module, wherein the storage module stores a plurality of authorized attendees and information associated with the authorized attendees, and the information comprises a unique identifier of the terminal, and the control module obtains the unique identifier of the terminal after receiving the request from the terminal, compares the current unique identifier with all unique identifiers in the storage module, and determines that the terminal is authorized if the current unique identifier matches one of the unique identifiers in the storage module.

7. A method for transmitting slide file during slide file presentation applied in an electronic device, the method comprising:
displaying one or more slide files;
receiving a request for downloading a displayed slide file from a terminal;
determining a corresponding slide file according to the received request if more then one of the one or more slide files are displayed; and
transmitting the determined slide file to the terminal during the slide file presentation.

8. The method as described in claim 7, wherein the received request comprises an image captured from a page of one of the displayed slide files by the terminal, and the step of “determining a corresponding slide file according to the received request if more than one of the one or more slide files are displayed” comprises:
extracting characters from the captured image; and
searches the characters in the displayed slide files to determine the corresponding slide file according to the received request.

9. The method as described in claim 7, wherein the step of “transmitting the determined slide file to the terminal during the slide files presentation” comprises:
compressing the determined slide file; and
transmitting the compressed slide file to the terminal.

10. The method as described in claim 8, wherein the step of “transmitting the determined slide file to the terminal during the slide files presentation” comprises:
determining whether the terminal is authorized to receive the determined slide file before transmitting the determined slide file to the terminal; and
transmitting the determined slide file to the terminal if the terminal is determined to be authorized to receive the determined slide file.
